(19) United States
(12) Patent Application Publication
(10) Pub. No.: US 2009/0033503 A1
(43) Pub. Date: Feb. 5, 2009

(54) USE OF HEATING AND/OR VENTILATION DUCTWORK TO BROADCAST ALARM CONDITIONS

(76) Inventor: Tryggvi EMILSSON, Champaign, IL (US)

Correspondence Address: Dennis H. Rainear, 13400 College Valley Lane, Richmond, VA, 23233, US

(21) Appl. No.: 11/831,162

(22) Filed: Jul. 31, 2007

(51) Int. Cl. G08B 17/00; G08B 21/00; G08B 3/00

(52) U.S. Cl. 340/584; 340/384.1; 340/540

(57) ABSTRACT

The present disclosure provides an audible alarm system that utilizes air-conveying ductwork to transport the audible alarm signal from the point of origination to a distant location. This system is low cost and improves the safety of individuals and reduces the potential loss of property by providing early and better hazard communication.

### FIELD OF THE INVENTION

The present invention relates to an economical means of broadcasting alarm conditions that may occur in basements, utility rooms or other seldom occupied areas to the areas of residential and/or commercial premises that are more likely to be occupied. This invention uses ductwork to spread the sound of a hazard detector (e.g. smoke, heat, carbon monoxide, or flood detector) placed in a basement or utility room to other areas of the premises.

### BACKGROUND OF THE INVENTION

A large assortment of smoke and/or CO alarms is available in any hardware store. These units are generally reliable and affordable. They often operate for a year or more on one inexpensive battery. If alarm or hazard conditions occur (for example, smoke, unauthorized entry or high CO concentration) they are often designed to produce a high pitched, ear piercing sound, loud enough to awaken most people in the immediate vicinity.

Many residential and commercial buildings are heated by forced air furnaces, fueled by natural gas, or oil. These units (as well as water heaters) are typically located in basements or utility rooms, which are quite often acoustically insulated from the rest of the premises. Malfunction of furnaces and water heaters are common causes of fires and/or carbon monoxide poisoning. Placing typical alarm devices (as described above) in these areas offers less than desired protection, because the sound is generally not effectively transmitted to dwelling areas. Alarm systems do exist, that feature remote sound sources, linked to the actual alarm sensors through wires, or through radio-frequency transmitters. This adds much to the cost and to the needed maintenance.

There is therefore a need for an effective and highly economical broadcasting hazard alarm system.

### SUMMARY OF THE DISCLOSURE

In one embodiment of the present disclosure is provided an alarm system comprising

(a) a sensor;

(b) an electronic alarm generator; and

(c) a sound generating device, connectable to heating or air conditioning ductwork.

In another embodiment, the alarm has a visual display instead of a sound generating device. Such a visual display can include, for example, a flashing light for gaining the attention of the hearing impaired.

Another embodiment herein provides an alarm system comprising (a) a hazard sensor, (b) an audible sound source; and (c) a connector to connect the sound source to a heating or air conditioning ductwork system. Alternatively, the connector can be a means to couple the sound source to the ductwork.

A key feature of the present disclosure is to provide a method of improving an audible hazard alarm system having a hazard sensor, also referred to herein as a detector, and an audible sound emitting device, wherein the improvement comprises attaching the audible sound emitting device of the hazard alarm system to a heating or air conditioning system having ductwork.

It is to be understood that both the foregoing general description and the following detailed description are exemplary and explanatory only and are intended to provide further explanation of the present disclosure, as claimed.

### BRIEF DESCRIPTION OF THE DRAWINGS

FIG. 1 illustrates one embodiment of the present disclosure.

FIG. 2 illustrates another embodiment of the present disclosure.

FIG. 3 illustrates another embodiment of the present disclosure.

FIG. 4 illustrates another embodiment of the present disclosure.

### DETAILED DESCRIPTION OF THE PRESENT DISCLOSURE

The disclosure herein provides an alarm system able to connect to a venting or ductwork system in a home or commercial building whereby an economical and inexpensive improvement is provided to the safety and hazard notification of the home or commercial building.

In one embodiment, the present alarm system includes a detector, an audible-sound-emitting alarm device, and a tube connecting the audible-sound-emitting alarm device to a ductwork system capable of use for conduction of air throughout a facility.

In another embodiment of the present disclosure the sound generating device is placed within the ductwork. In yet another embodiment the sound generating device is attached to the outside of the wall of the ductwork, in such a manner that the sound vibrations get coupled to the wall, which in turn produces a loud sound within the duct. This embodiment eliminates the need to perforate the duct wall. Another embodiment provides a kit for adapting a hazard audible alarm system to create a facility-wide warning system through the facility's air ductworks. Such a kit herein can, in one embodiment, comprise one or more typical unmodified hazard detectors (including but not limited to smoke, heat, carbon monoxide, motion or water) and a device which is attached to the ductwork in any of the ways described above. This device detects the sound produced by any of the hazard detectors in the vicinity, and in turn feeds it or a much louder sound into the ductwork.

By “ductworks” herein is meant any and all hollow devices, hoses, tubes, vents, piping, or structures for conveying air from one location to another in a facility. The ductworks can be formed of, for example and not as a limitation herein, one or more metals (such as aluminum or galvanized iron), composite board, wood, paper, paperboard, plastic or other rigid or semi-rigid materials, and combinations thereof. The ductwork can in one embodiment be square or rectangular in cross-section or can be circular in the case of, for example, flexible large tubes or hoses.

Alarm systems of the various embodiments herein feed sound into existing ductwork, so that the audible alarm is heard, loudly and clearly, throughout the premises served by this ductwork. By this manner the cost and effort of installing sensors in sound-proof areas is dramatically lowered or eliminated, and this system thus has a much higher chance of saving lives and reducing property damage. The following examples further illustrate aspects of the present disclosure but do not limit the present invention.

### EXAMPLES

In the following examples a “typical alarm device” comprises:
a) a “sensor” or “detector” adapted to generate an identifiable electrical signal in response to a hazard such as ambient levels of smoke, heat, unauthorized entry or motion, carbon monoxide, water or other alarm conditions;
b) an electronic “processor” adapted to monitor the electric signal generated by the “sensor” and adapted to determine if sufficient alarm levels are present to warrant activating the sound source, and then if necessary cause the sound source to produce sound; and
c) a “sound source”.

### Example 1

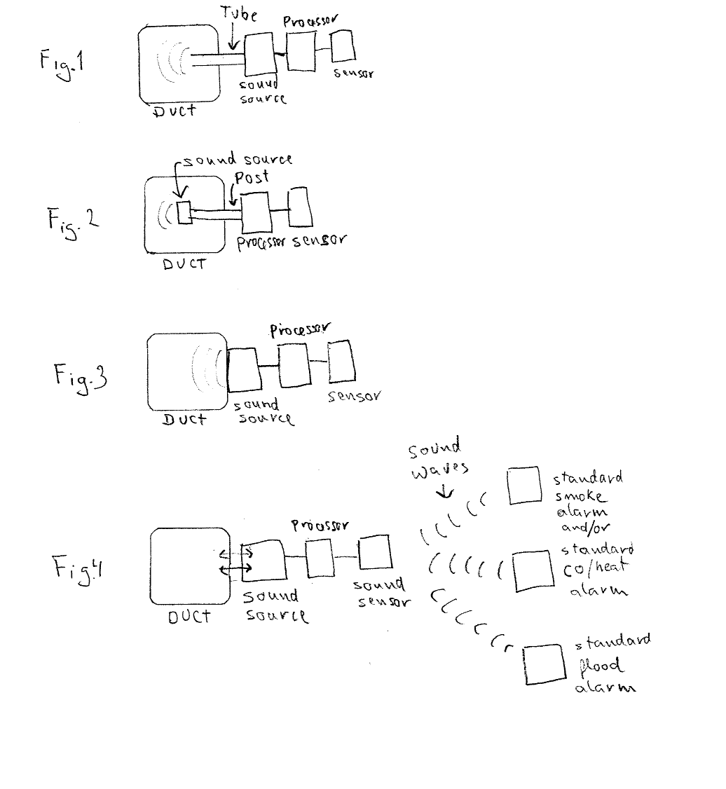

A short tube is attached to the sound source of a typical alarm device. This tube is inserted or plugged into a hole drilled into existing ductwork of a heating or air conditioning system. (FIG. 1)

### Example 2

The sound source is removed from a typical alarm device and replaced with a short post. The sound source is then attached to the end of this post. The post and sound source are then inserted into the ductwork, through a hole of appropriate size. (FIG. 2)

### Example 3

A sound source is attached on the outside of existing ductwork, so that the audible alarm signal is fed through the wall of the duct. (FIG. 3)

### Example 4

A sound source is attached to ductwork as in any of the examples above. This device is adapted to detect sound from other hazard detectors in the vicinity and respond by generating a loud sound into the ductwork. (FIG. 4)

Other embodiments of the present invention will be apparent to those skilled in the art from consideration of the specification and practice of the invention disclosed herein. It is intended that the specification and examples be considered as exemplary only, with a true scope and spirit of the invention being indicated by the following claims. This invention is susceptible to considerable variation in its practice. Accordingly, this invention is not limited to the specific exemplifications set forth hereinabove. Rather, this invention is within the spirit and scope of the appended claims, including the equivalents thereof available as a matter of law.

The patentee does not intend to dedicate any disclosed embodiments to the public, and to the extent any disclosed modifications or alterations may not literally fall within the scope of the claims, they are considered to be part of the invention under the doctrine of equivalents.

What is claimed is:

1. An alarm system comprising
(a) a hazard sensor,
(b) an audible sound source; and
(c) a connector to connect the sound source to a heating or air conditioning ductwork system.

2. The alarm system of claim 1, wherein the sensor is able to generate a signal in response to detecting a hazard.

3. The alarm system of claim 2, further comprising an electronic processor adapted to monitor the signal from the sensor and determine if the hazard level is sufficient to activate the sound source to emit a sound.

4. The alarm system of claim 1, wherein the hazard is selected from the group consisting of heat, smoke, carbon monoxide, motion and flood.

5. The alarm system of claim 3, wherein the processor is able to receive the signal generated by the sensor and induce the sound source to generate an audible alarm in response thereto.

6. The alarm system of claim 1, wherein the sound source is connected to a duct of the heating or air conditioning system.

7. The alarm system of claim 1, wherein the connector comprises a hollow tube.

8. The alarm system of claim 1, wherein the sound source is mounted on a solid post, which protrudes into the ductwork.

9. The alarm system of claim 1, wherein the sound source is mounted on the outside of the duct and the sound is conveyed through the wall of the duct.

10. The alarm system of claim 1, wherein the heating or air conditioning system comprises ductwork extending at least beyond a room containing the sensor.

11. The alarm system of claim 1, wherein the heating or air conditioning system comprises ductwork extending at least beyond a room containing the sound source.

12. The alarm system of claim 1, wherein the sound source is connected to the heating or air conditioning ductwork system.

13. A method of improving an audible hazard alarm system having a hazard sensor and an audible sound emitting alarm, wherein the improvement comprises attaching a sound source from the hazard alarm system to a heating or air conditioning system having ductwork.

14. The method of claim 13 further comprising allowing the sound from the alarm to be conducted into the ductwork and conveyed therein to locations serviced by said heating or air conditioning system ductwork.

15. The method of claim 13, wherein the sound is conducted into the ductwork from the alarm by a hollow tube.

16. The method of claim 13, wherein the sound source is mounted on a solid post, which protrudes into the ductwork.

19. A kit for adapting an alarm system to a heating or air conditioning system, said kit comprising a connector for contacting the alarm system to the heating or air conditioning system.
